(19) United States
(12) Patent Application Publication
(10) Pub. No.: US 2025/0193876 A1
(43) Pub. Date: Jun. 12, 2025

(54) POWER BOOSTING FOR RESOURCE ELEMENT MUTING

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/533,004

(22) Filed: Dec. 7, 2023

(51) Int. Cl. H04W 72/1268; H04L 5/00; H04W 72/044; H04W 72/231

(52) U.S. Cl. CPC H04W 72/1268; H04W 72/0473; H04W 72/231; H04L 5/0007

(57) ABSTRACT

Aspects relate to resource element muting. A first apparatus may obtain a first configuration that schedules a resource for the first apparatus. The first apparatus may then output a first symbol of a plurality of symbols for transmission via the resource. In some examples, a first resource element of the first symbol is muted according to a muting pattern and a second resource element of the first symbol is power boosted.

### TECHNICAL FIELD

The technology discussed below relates generally to wireless communication and, more particularly, to power boosting used in conjunction with muting of a resource element.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station.

A base station may schedule access to a cell to support access by multiple UEs. For example, a base station may allocate different resources (e.g., time domain and frequency domain resources) to be used by different UEs operating within the cell. Thus, each UE may transmit information to the base station via one or more of these resources and/or the base station may transmit information to one or more of the UEs via one or more of these resources.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a first apparatus for communication may include a processing system. The processing system may be configured to obtain a first configuration that schedules a resource for the first apparatus. The processing system may also be configured to output a first symbol of a plurality of symbols for transmission via the resource, a first resource element of the first symbol being muted according to a muting pattern and a second resource element of the first symbol being power boosted.

In some examples, a method for communication at a first apparatus is disclosed. The method may include obtaining a first configuration that schedules a resource for the first apparatus. The method may also include outputting a first symbol of a plurality of symbols for transmission via the resource, a first resource element of the first symbol being muted according to a muting pattern and a second resource element of the first symbol being power boosted.

In some examples, a first apparatus for communication may include means for obtaining a first configuration that schedules a resource for the first apparatus. The first apparatus may also include means for outputting a first symbol of a plurality of symbols for transmission via the resource, a first resource element of the first symbol being muted according to a muting pattern and a second resource element of the first symbol being power boosted.

In some examples, a non-transitory computer-readable medium has stored therein instructions executable by a processing system of a first apparatus to obtain a first configuration that schedules a resource for the first apparatus. The computer-readable medium may also have stored therein instructions executable by the processing system of the first apparatus to output a first symbol of a plurality of symbols for transmission via the resource, a first resource element of the first symbol being muted according to a muting pattern and a second resource element of the first symbol being power boosted.

In some examples, a user equipment for communication may include a transceiver and a processing system. The transceiver may be configured to receive a first configuration that schedules a resource for the first apparatus. The processing system may be configured to output a first symbol of a plurality of symbols for transmission via the resource, a first resource element of the first symbol being muted according to a muting pattern and a second resource element of the first symbol being power boosted. The transceiver may also be configured to transmit the first symbol.

In some examples, a first apparatus for communication may include a processing system. The processing system may be configured to output a first configuration for transmission, the first configuration scheduling a resource for a second apparatus. The processing system may also be configured to obtain a first symbol of a plurality of symbols via the resource, a first resource element of the first symbol being muted according to a muting pattern and a second resource element of the first symbol being power boosted.

In some examples, a method for communication at a first apparatus is disclosed. The method may include outputting a first configuration for transmission, the first configuration scheduling a resource for a second apparatus. The method may also include obtaining a first symbol of a plurality of symbols via the resource, a first resource element of the first symbol being muted according to a muting pattern and a second resource element of the first symbol being power boosted.

In some examples, a first apparatus for communication may include means for outputting a first configuration for transmission, the first configuration scheduling a resource for a second apparatus. The first apparatus may also include means for obtaining a first symbol of a plurality of symbols via the resource, a first resource element of the first symbol being muted according to a muting pattern and a second resource element of the first symbol being power boosted.

In some examples, a non-transitory computer-readable medium has stored therein instructions executable by a processing system of a first apparatus to output a first configuration for transmission, the first configuration scheduling a resource for a second apparatus. The computer-readable medium may also have stored therein instructions executable by the processing system of the first apparatus to obtain a first symbol of a plurality of symbols via the resource, a first resource element of the first symbol being muted according to a muting pattern and a second resource element of the first symbol being power boosted.

In some examples, a network entity for communication may include a transceiver and a processing system. The processing system may be configured to output a first configuration for transmission, the first configuration scheduling a resource for a second apparatus. The transceiver may be configured to transmit the first configuration. The transceiver may also be configured to receive a first symbol of a plurality of symbols via the resource, a first resource element of the first symbol being muted according to a muting pattern and a second resource element of the first symbol being power boosted.

These and other aspects of the disclosure will become more fully understood upon a review of the detailed description which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein.

In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a schematic illustration of wireless resources in an air interface utilizing orthogonal frequency divisional multiplexing (OFDM) according to some aspects.

FIG. 5 is a schematic illustration of an example of an apparatus for communication according to some aspects.

FIG. 6A is a diagram illustrating an example of a frame structure of synchronization signals for use in a wireless communication network according to some aspects.

FIG. 6B is a diagram illustrating an example of a portion of a frame or subframe structure with various channels and associated messages for use in a wireless communication network according to some aspects.

FIG. 7A is a diagram illustrating two examples of in-band full-duplex (IBFD) according to some aspects.

FIG. 7B is a diagram illustrating an example of sub-band full-duplex (SBFD) according to some aspects.

FIG. 8 is a diagram depicting an example of an SBFD slot according to some aspects.

FIG. 9 is a schematic illustration of examples of interference scenarios according to some aspects.

FIG. 10 illustrates an example of an UL muting pattern applied to an SBFD slot according to some aspects.

FIG. 11 is a signaling diagram illustrating an example of resource element muting-related signaling according to some aspects.

FIG. 12 is a block diagram conceptually illustrating an example of a hardware implementation for an apparatus (e.g., a user equipment) employing a processing system according to some aspects.

FIG. 13 is a flow chart illustrating an example communication method involving resource element muting according to some aspects.

FIG. 14 is a block diagram conceptually illustrating an example of a hardware implementation for an apparatus (e.g., a network entity) employing a processing system according to some aspects.

FIG. 15 is a flow chart illustrating an example communication method involving resource element muting according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

To enhance the quality of the cross-link interference (CLI) related measurements at a network entity, certain uplink (UL) resources used by UEs served by the network entity may be muted. For example, an UL resource muting pattern may specify that one or more resource elements (REs) or resource blocks (RBs) that have been scheduled for an UL transmission are to be muted.

The disclosure relates in some aspects to boosting the power of non-muted REs or RBs in a symbol that has at least one muted resource element (RE) or resource block (RB). In some examples, this boosting procedure may be referred to as energy per resource element (EPRE) boosting.

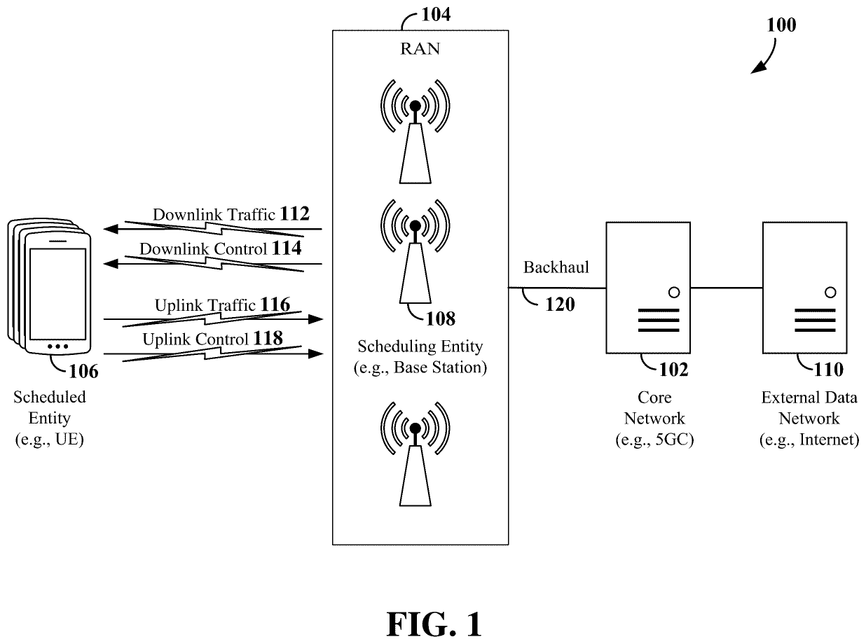

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), a vehicle (e.g., an automobile, a bus, etc.) and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

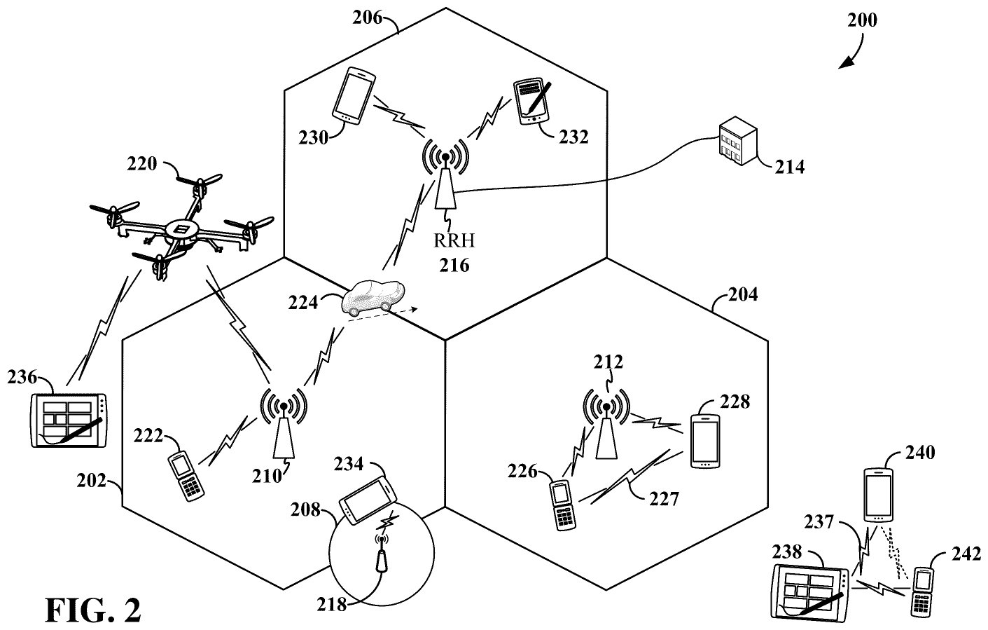

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, the DUs, and the RUs also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

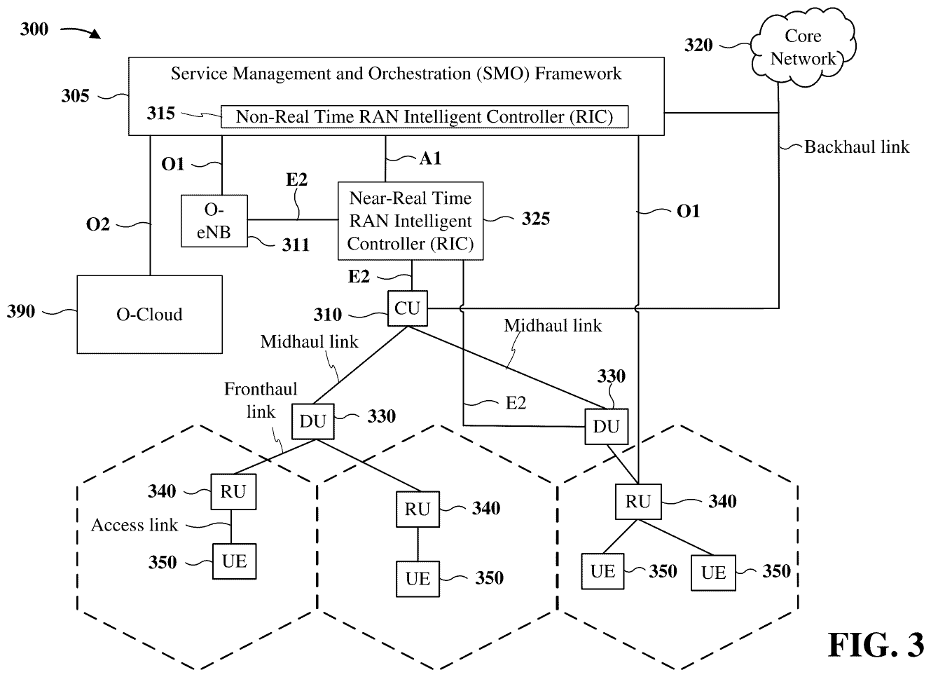

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the distributed unit (DU) 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

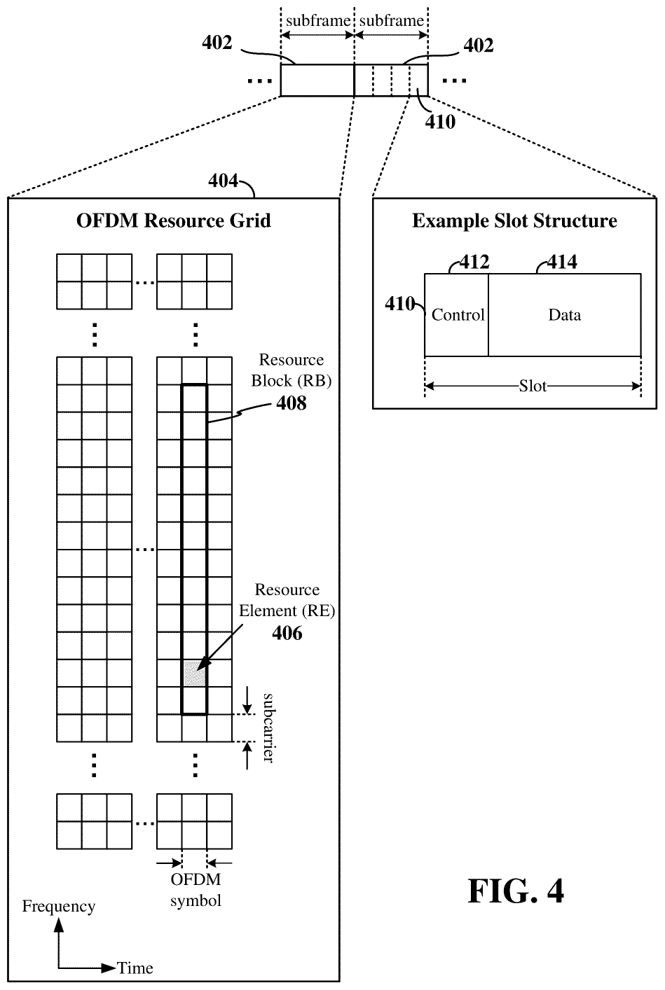

Various aspects of the present disclosure will be described with reference to an OFDM waveform, an example of which is schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an example subframe 402 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely an example, and different slot structures may be utilized, and may include one or more of each of the control region(s) and data region(s).

Although not illustrated in FIG. 4, the various REs 406 within an RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-4 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

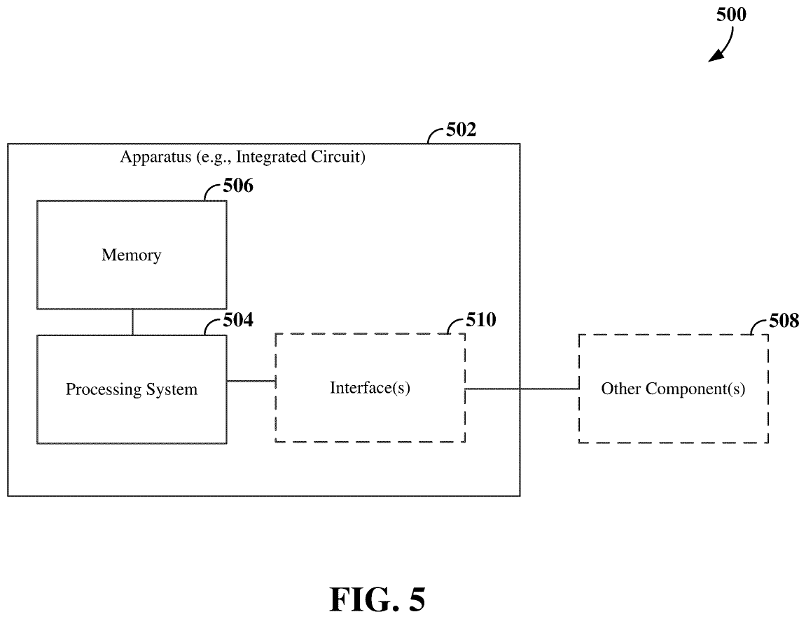

FIG. 5 illustrates an example apparatus 500 according to certain aspects of the disclosure. In some examples, the apparatus 500 may be a BS, a UE, or some other type of wireless node (e.g., a node that utilizes wireless spectrum (e.g., the RF spectrum) to communicate with another node or entity). In some examples, the apparatus 500 may correspond to any of the apparatuses, UEs, scheduled entities, network entities, base stations (e.g., gNBs), scheduling entities, DUs, CUs, RAN nodes, or CN entities shown in any of FIGS. 1, 2, 3, 9, 11, 12, and 14.

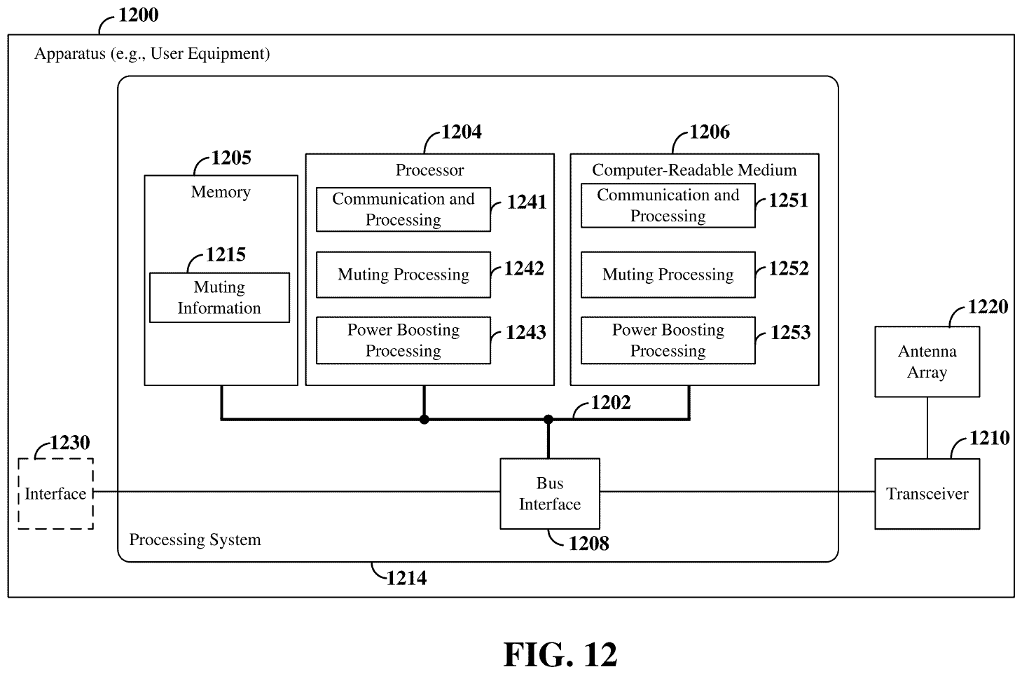

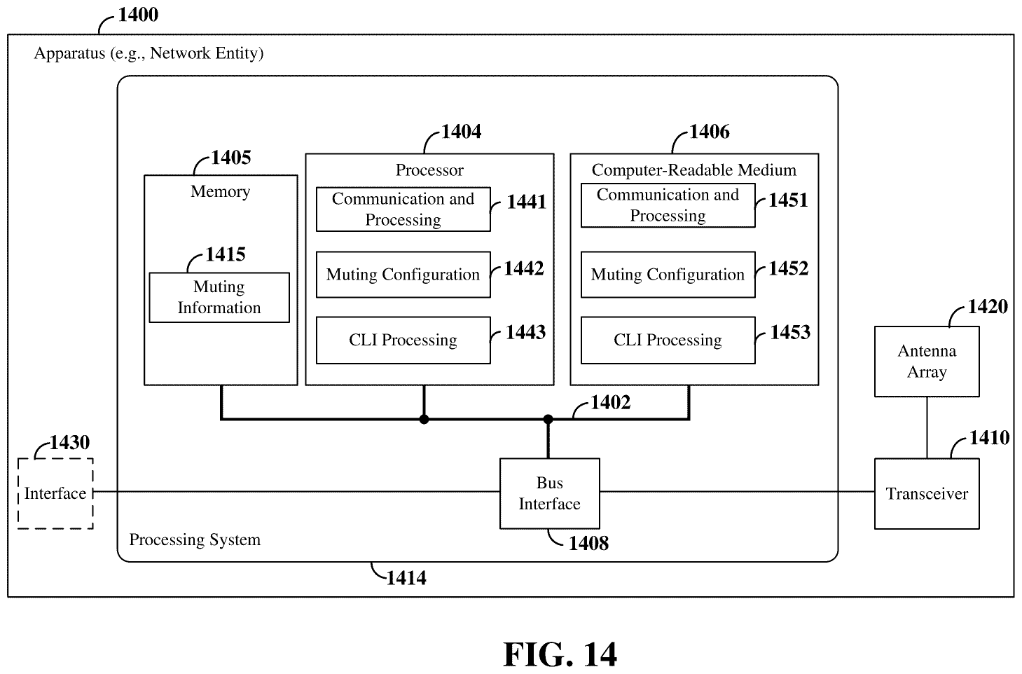

The apparatus 500 includes an apparatus 502 (e.g., an integrated circuit) and, optionally, at least one other component 508. In some aspects, the apparatus 502 may be configured to operate in a wireless communication device (e.g., a UE, a BS, etc.) and to perform one or more of the operations described herein. The apparatus 502 includes a processing system 504, and a memory 506 coupled to the processing system 504. Example implementations of the processing system 504 are provided herein. In some examples, the processing system 504 of FIG. 5 may correspond to the processing system 1214 of FIG. 12. In some examples, the processing system 504 of FIG. 5 may correspond to the processing system 1414 of FIG. 14.

The processing system 504 is generally adapted for processing, including the execution of such programming stored on the memory 506. For example, the memory 506 may store instructions that, when executed by the processing system 504, cause the processing system 504 to perform one or more of the operations described herein.

In some implementations, the apparatus 502 communicates with at least one other component (e.g., a component 508 external to the apparatus 502) of the apparatus 500. To this end, in some implementations, the apparatus 502 may include at least one interface 510 (e.g., a send and/or receive interface) coupled to the processing system 504 for outputting and/or obtaining (e.g., sending and/or receiving) information (e.g., received information, generated information, decoded information, messages, etc.) between the processing system 504 and the other component(s) 508. In some implementations, the interface 510 may include an interface bus, bus drivers, bus receivers, buffers, other suitable circuitry, or a combination thereof. In some implementations, the interface 510 may include radio frequency (RF) circuitry (e.g., an RF transmitter and/or an RF receiver). In some implementations, the interface 510 may be configured to interface the apparatus 502 to one or more other components of the apparatus 500 (other components not shown in FIG. 5). For example, the interface 510 may be configured to interface the processing system 504 to a radio frequency (RF) front end (e.g., an RF transmitter and/or an RF receiver).

The apparatus 502 may communicate with other apparatuses in various ways. In cases where the apparatus 502 includes an RF transceiver (not shown in FIG. 5), the apparatus may transmit and receive information (e.g., a frame, a message, bits, etc.) via RF signaling. In some cases, rather than transmitting information via RF signaling, the apparatus 502 may have an interface to provide (e.g., output, send, transmit, etc.) information for RF transmission. For example, the processing system 504 may output information, via a bus interface, to an RF front end for RF transmission. Similarly, rather than receiving information via RF signaling, the apparatus 502 may have an interface to obtain information that is received by another apparatus. For example, the processing system 504 may obtain (e.g., receive) information, via a bus interface, from an RF receiver that received the information via RF signaling. In some implementations, an interface may include multiple interfaces. For example, a bidirectional interface may include a first interface for obtaining and a second interface for outputting.

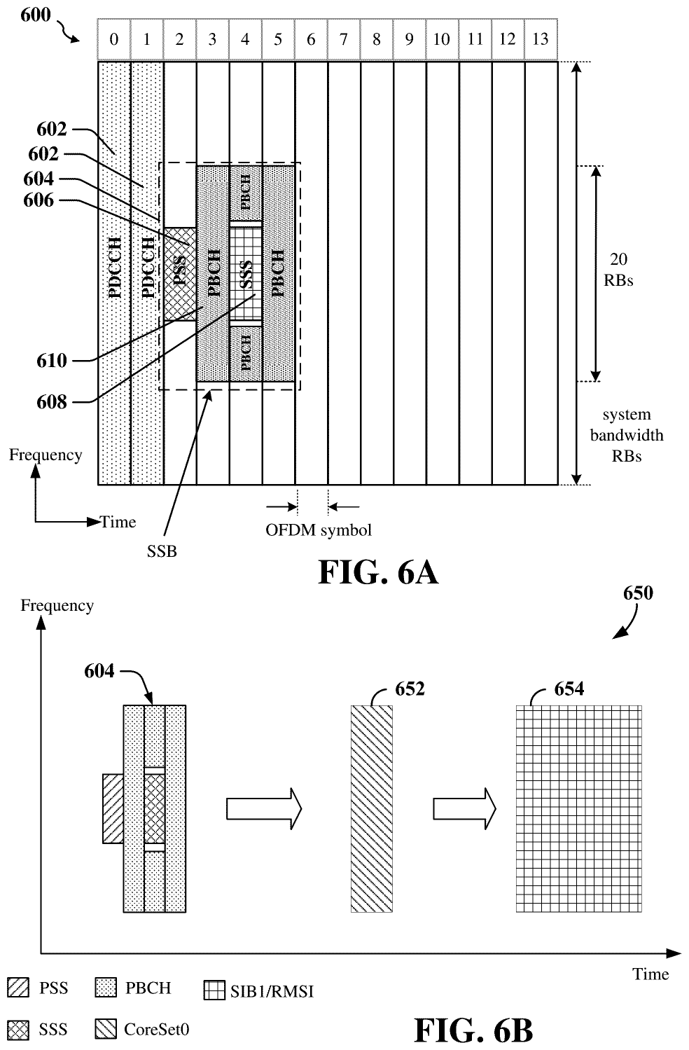

FIG. 6A illustrates an example 600 of various downlink channels within a subframe of a frame including channels used for initial access and synchronization. As shown in FIG. 6A, a physical downlink control channel (PDCCH) 602 is transmitted in at least two symbols (e.g., symbol 0 and symbol 1) and may carry DCI within at least one control channel element (CCE), with each CCE including nine RE groups (REGs), and each RE group (REG) including four consecutive REs in an OFDM symbol. Additionally, FIG. 6A illustrates an exemplary synchronization signal block (SSB) 604 that may be periodically transmitted by a base station or gNB. The SSB 604 carries synchronization signals PSS 606 and SSS 608 and broadcast channels (PBCH) 610. In this example, the SSB 604 contains one PSS symbol (shown in symbol 2), one SSS symbol (shown in symbol 6) and two PBCH symbols (shown in symbols 3 and 5). The PSS and SSS combination may be used to identify physical cell identities. A UE uses the PSS to determine subframe/symbol timing and a physical layer identity. The SSS is used by a UE to determine a physical layer cell identity group number and radio frame timing. Based on the physical layer identity and the physical layer cell identity group number, the UE can determine a physical cell identifier (PCI). Also, based on the PCI, the UE can determine the locations of the aforementioned DMRS. The physical broadcast channel (PBCH), which carries a master information block (MIB), is logically grouped with the PSS and SSS to form the synchronization signal; i.e., the SSB 604. The MIB provides a number of RBs in the system bandwidth and a system frame number (SFN).

FIG. 6B is a diagram illustrating various broadcast information 650 related to initial cell access according to some examples. The broadcast information 650 may be transmitted by a RAN node (e.g., a base station, such as an eNB or gNB) on resources (e.g., time-frequency resources) allocated for the transmission of the broadcast information 650 in a cell. The broadcast information 650 includes the SSB 604 illustrated in FIG. 6A. It is noted that the PBCH in the SSB 604 includes the MIB carrying various system information (SI) including, for example, a cell barred indication, the subcarrier spacing, the system frame number, and scheduling information for a CORESET0 652. For example, the PBCH in the SSB 604 may include scheduling information indicating time-frequency resources allocated for the CORESET0 652. In some examples, the CORESET0 652 may be transmitted within the first four symbols (e.g., within a control region) of a slot. In addition, the CORESET0 652 carries a PDCCH with DCI that contains scheduling information for scheduling the SIB1 654. The SIB1 654 is carried within a physical downlink shared channel (PDSCH) within a data region of a slot. In addition, the SIB1 654 may be referred to as RMSI and includes, for example, a set of radio resource parameters providing network identification and configuration. For example, the set of radio resource parameters may include a bandwidth (e.g., number of BWPs) on which a UE may communicate with a base station.

The MIB in the PBCH may include system information (SI), along with parameters for decoding a SIB (e.g., SIB1). Examples of SI transmitted in the MIB may include, but are not limited to, a subcarrier spacing, a system frame number, a configuration of a PDCCH control resource set (CORESET) (e.g., PDCCH CORESET0), and a search space for SIB1. Examples of SI transmitted in the SIB1 may include, but are not limited to, a random access search space, downlink configuration information, and uplink configuration information. The MIB and SIB1 together provide the minimum SI for initial access.

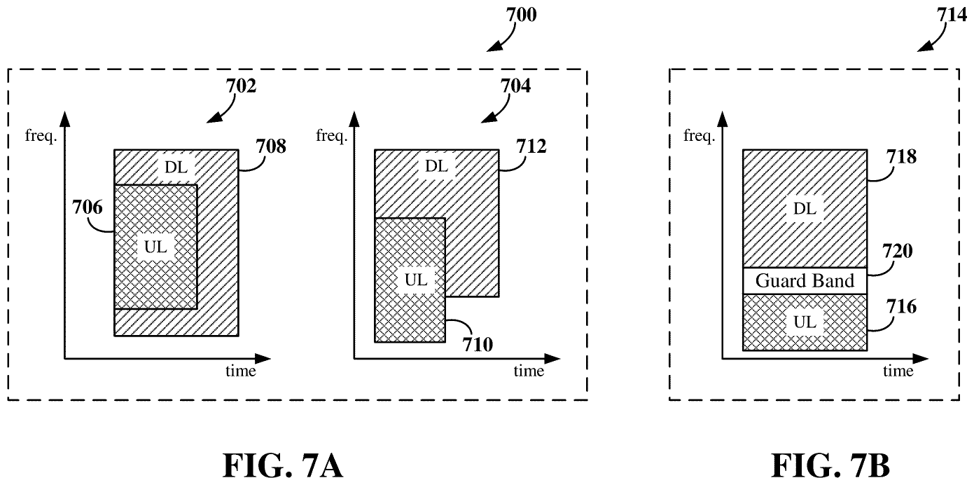

As mentioned above, a UE and/or a base station (e.g., gNB) may use full-duplex communication. Various examples of full-duplex operation are illustrated in FIGS. 7A and 7B. FIG. 7A is a diagram illustrating two examples of in-band full-duplex (IBFD) modulation 700 according to some aspects of the disclosure. In the examples shown in FIG. 7A, time is illustrated along the horizontal axis while frequency is illustrated along the vertical axis. A first example 702 of IBFD is depicted on the left while a second example 704 is depicted on the right. In the first example 702, the UL time-frequency resources 706 completely overlap with a portion of the DL time-frequency resources 708. In the second example 704, the UL time-frequency resources 710 partially overlap with a portion of the DL time-frequency resources 712. Accordingly, a device, for example a network entity, employing IBFD may transmit and receive on the same time and frequency resources. That is, the device may transmit and receive at the same time(s) at the same frequency (or frequencies). The UL and DL share the same time and frequency resources. The overlap in time-frequency resources may be complete (full overlap), as in the first example 702, or partial, as in the second example 704.

FIG. 7B is a diagram illustrating an example of SBFD 714 according to some aspects of the disclosure. In the example shown in FIG. 7B, time is illustrated along the horizontal axis while frequency is illustrated along the vertical axis. In SBFD 714, a device may transmit and receive at the same time but on different frequency resources (e.g., different sub-bands within the same carrier bandwidth). In some examples, the different frequency resources may be in unpaired spectrum. The UL resources 716 are separated from the DL resources 718 by a guard band 720. In some scenarios, the guard band 720 may be relatively narrow (e.g., a few RBs). Consequently, a transmission in the UL resources 716 may result in leakage in the DL resources 718, and vice versa.

For a full-duplex scenario, a slot format may be defined as a ‘D+U’ slot. For example, a ‘D+U’ slot may be a slot in which the band is used for both UL and DL transmissions. The DL and UL transmissions can occur in overlapping bands (in-band full-duplex) or adjacent bands (sub-band full-duplex). In a given ‘D+U’ symbol, the HD UE either transmits in the UL band or receives in the DL band. In a given ‘D+U’ symbol, an FD UE can transmit in the UL band and/or receive in the DL band in the same slot. A ‘D+U’ slot can contain DL only symbols, UL only symbols, or full-duplex symbols.

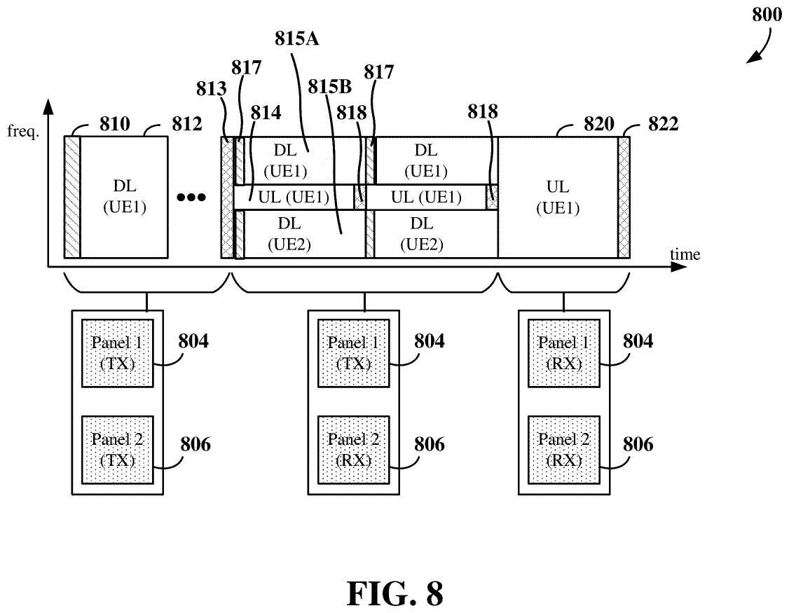

In some examples, a network entity (e.g., a base station) may use two panels (or two TRPs) to operate in either a TDD mode (with both panels on the gNB and one or more panels on the UE configured for either DL or UL) or an SBFD mode (with one panel on each of the gNB and UE configured for UL and another panel on each of a network entity and UE configured for DL) as described below with reference to the slot 800 shown in FIG. 8.

At the left of FIG. 8, when an antenna array is communicating in only a single direction at a time, both panel 1 804 and panel 2 806 may be configured for the single-direction communication as an example of a TDD mode showing the DL transmission.

For example, both panels 804 and 806 may be configured to transmit DL control 810 and DL data 812 to a first UE (UE1) as an example of DL transmissions during TDD mode.

At the center of FIG. 8, both panels 804 and 806 may also be configured to transmit SRS 813 that can be received by the first UE (UE1) and a second UE (UE2). In addition, the antenna array may simultaneously transmit a combination of DL data 815A and 815B and DL control 817 and receive UL data 814 (e.g., PUSCH) and UL control 818. In this case, panel 1 804 may be configured for DL transmission (i.e., TX) and panel 2 806 may be configured for UL reception (i.e., RX). Here, the DL data 815A may be destined for the first UE (UE1) and the DL data 815B may be destined for the second UE (UE2).

At the right of FIG. 8, when the antenna array is only receiving UL data 820 (e.g., PUSCH) and UL control 822 (e.g., from the first UE (UE1), both panel 1 804 and panel 2 806 may be configured for UL reception. The antenna array is thus configurable for both TDD and full-duplex operation (e.g., flexible TDD). The physical separation 808 between panel 1 804 and panel 2 806 may provide improved isolation between the panels (e.g., greater than about 50 dB of improved isolation) when compared to two panels without the physical separation 808. The above discussion also may be applicable to an antenna array in various types of devices (e.g., a UE, with the references to DL and UL reversed).

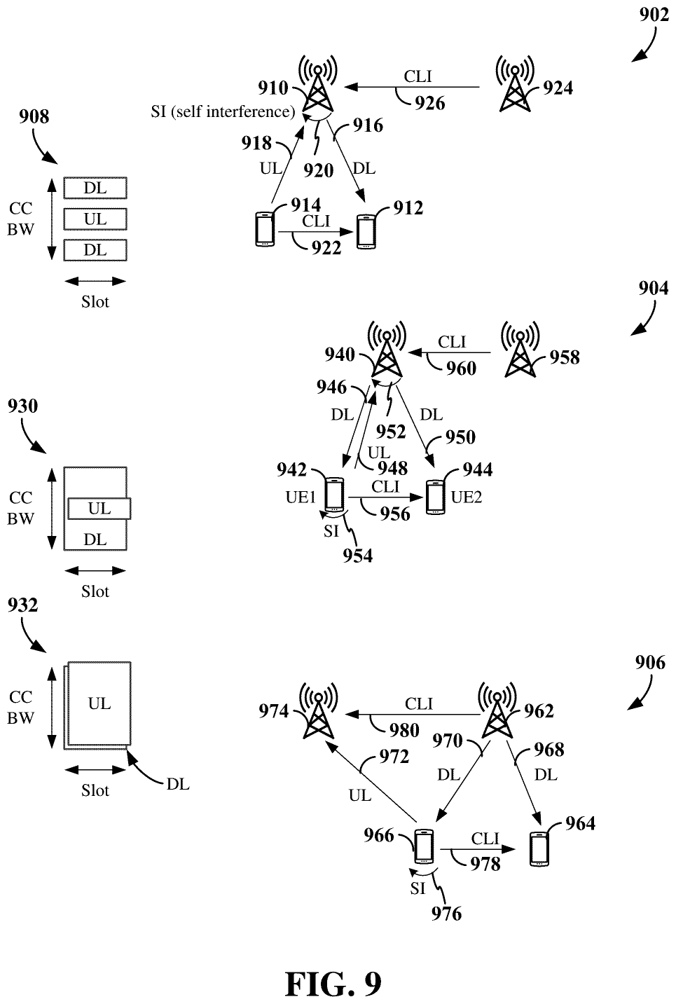

FIG. 9 illustrates several examples of full-duplex interference scenarios including a first scenario 902, a second scenario 904, and a third scenario 906. Other interference scenarios may be possible.

In the first scenario 902, a network entity such as a base station 910 (e.g., a full-duplex gNB) uses SBFD communication 908 to concurrently communicate with a UE 912 (e.g., a half-duplex UE) and a UE 914 (e.g., a half-duplex UE). For example, the base station 910 may transmit a downlink transmission 916 to the UE 912 at the same time that the UE 914 transmits an uplink transmission 918 to the base station 910. In this case, the downlink transmission 916 may result in self-interference 920 at the base station 910 when the base station 910 is attempting to decode the uplink transmission 918. In addition, the uplink transmission 918 may result in cross-link interference (CLI) 922 at the UE 912 when the UE 912 is attempting to decode the downlink transmission 916.

Also in the first scenario 902, a base station 924 (e.g., a full-duplex gNB) may transmit a downlink transmission to a UE (not shown) at the same time that the UE 914 transmits the uplink transmission 918 to the base station 910. In this case, the downlink transmission by the base station 924 may result in cross-link interference 926 at the base station 910 when the base station 910 is attempting to decode the uplink transmission 918.

In the second scenario 904, a network entity such as a base station 940 (e.g., a full-duplex gNB) concurrently uses full-duplex communication 930 or 932 to communicate with a UE 942 (a full-duplex UE) and half-duplex communication to communicate with a UE 944 (e.g., a half-duplex UE). For example, the base station 940 may transmit a downlink transmission 946 to the UE 942 at the same time that the UE 942 transmits an uplink transmission 948 to the base station 940. In addition, at the same time, the base station 940 may transmit a downlink transmission 950 to the UE 944. In this case, the downlink transmission 946 or 950 may result in self-interference 952 at the base station 940 when the base station 940 is attempting to decode the uplink transmission 948. In addition, the uplink transmission 948 may result in self-interference 954 at the UE 942 when the UE 942 is attempting to decode the downlink transmission 946. Also, the uplink transmission 948 may result in cross-link interference (CLI) 956 at the UE 944 when the UE 944 is attempting to decode the downlink transmission 950. Furthermore, a downlink transmission by a nearby base station 958 may result in cross-link interference 960 at the base station 940 when the base station 940 is attempting to decode the uplink transmission 948.

In the third scenario 906, a network entity such as a base station (e.g., a full-duplex gNB) employs a first TRP 962 and a second TRP 974. The base station may communicate with a UE 964 (e.g., a half-duplex UE) and a UE 966 (e.g., a full-duplex UE) in this example. As shown, the first TRP 962 may transmit a downlink transmission 968 to the UE 964 at the same time that the first TRP 962 transmits a downlink transmission 970 to the UE 966. At the same time, the UE 966 may transmit an uplink transmission 972 to the second TRP 974. In this case, the uplink transmission 972 may result in self-interference 976 at the UE 966 when the UE 966 is attempting to decode the downlink transmission 970. In addition, the uplink transmission 972 may result in cross-link interference (CLI) 978 at the UE 964 when the UE 964 is attempting to decode the downlink transmission 968. Also, the downlink transmission 968 or 970 may result in cross-link interference (CLI) 980 at the second TRP 974 when the second TRP 974 is attempting to decode the uplink transmission 972.

In some examples, the base stations 910, 924, 940, and 958, the first TRP 962, and the second TRP 974 may correspond to any of the network entities, base stations, CUs, DUs, RUs, or scheduling entities shown in any of FIGS. 1, 2, 3, 5, 11, and 14. In some examples, the user equipment 912, 914, 942, 944, 964, and 966 may correspond to any of the UEs or scheduled entities shown in any of FIGS. 1, 2, 3, 5, 11, and 12.

Various techniques may be used to mitigate the effects of the network entity to network entity CLI (e.g., gNB to gNB CLI) discussed above. In some examples, a network entity may conduct channel measurements to determine the CLI. For example, a network entity may conduct co-channel CLI measurements, CLI interference covariance matrix measurements, or other measurements.

Based on these measurements, the network entities may cooperate (e.g., via appropriate signaling) to reduce the CLI at a given network entity when the network entity is attempting receive a transmission (e.g., from a UE). For example, the network entities may schedule their transmissions and/or receptions to avoid conflicts, adjust transmission parameters to mitigate the effects that transmissions by one network entity have on receptions at the other network entity, and so on.

To enhance the quality of the CLI-related measurements at a network entity discussed above, the network entity may mute uplink (UL) transmissions by the UEs served by the network entity that could otherwise interfere with the CLI-related measurements. The UL resource muting can be used to enable a network entity to measure the gNB-to-gNB CLI levels with less interference from the UL, to measure the gNB-to-gNB channel with less interference from the UL, or to measure the gNB-to-gNB CLI interference covariance matrix with less interference from the UL. For example, in RAN1 #112bis-e, for enhancement of gNB-to-gNB co-channel CLI measurement and/or channel measurement, two options were identified for UL resource muting. The first option involves a transparent UL resource muting method (e.g., avoid UL scheduling on the measurement resource). The second option involves a non-transparent UL resource muting method (e.g., define an UL resource muting pattern with one or more RE/RB muting patterns).

For UL muting, different uplink blank/muting resources can be used to measure spatial characteristics of gNB-to-gNB CLI caused by various DL signals and to avoid cross-link interference. The uplink resources muting pattern can be different for various DL channel(s)/signal(s). For gNB-to-gNB co-channel CLI measurement, the following muting operations may be supported. REs may be muted in an UL slot at the position of part of REs of an SSB, a SIB1, and/or a broadcast PDCCH from an aggressive cell (e.g., a nearby gNB) to enable a gNB to measure the spatial characteristics of downlink broadcast interference. REs may be muted in an UL slot at the position of part of the REs of unicast PDSCH and PDCCH from an aggressive cell to enable a gNB to obtain the spatial characteristics of unicast PDSCH and PDCCH CLI. REs may be muted in an UL slot at the position of the REs of NZP CSI-RS from an aggressive cell to enable a gNB to avoid strong CLI.

The disclosure relates in some aspects to a muting method that takes into consideration UE complexity and/or a potential increase in the peak-to-average power ratio (PAPR) due to non-contiguous UL transmissions when using non-transparent UL resource muting.

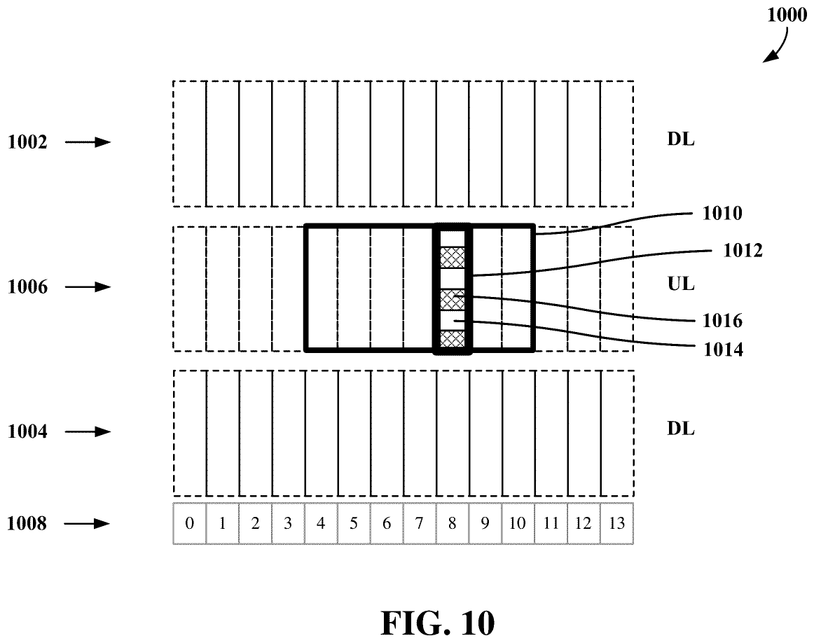

FIG. 10 illustrates an example of an UL muting pattern applied to an SBFD slot 1000. The SBFD slot 1000 includes DL resources 1002 (e.g., a first set of REs), DL resources 1004 (e.g., a second set of REs), and UL resources 1006 (e.g., a third set of REs) for an associated set of symbols 1008.

Within the UL resources 1006, a set of symbols 1010 (symbols 4-10 in this example) have been scheduled for an UL transmission (e.g., PUSCH) by a UE. In addition, an UL muting pattern 1012 has been applied to symbol 8 within the set of symbols 1010 for the UL transmission. It should be appreciated that other UL scheduling (e.g., different symbols) and different UL muting patterns may be used in other examples. For example, an UL muting pattern may be defined with RE granularity, RB granularity, or some other granularity. Also, an UL muting pattern may be applied to and/or defined for one symbol or multiple symbols.

In the UL muting pattern 1012, half of the REs are being muted. For example, the REs without crosshatching (e.g., RE 1014) may be the muted REs.

FIG. 10 may thus illustrate an example of a UE configured with an UL muting pattern overlapping with PUSCH. In some examples, this scenario may lead to unequal power across the symbols of a slot due to the muted REs/RBs. Here, the symbols with muted REs/RBs will have a lower power relative to other symbols that are not muted. In general, is it not desirable to have an unequal UL power per symbol since this may affect the PAPR of the waveform and the non-linearity of the power amplifier (PA) used to transmit the symbols. This, in turn, may affect the phase coherency between symbols (e.g., different PAPRs for different symbols may result in different phases for the transmitted symbols due to the characteristics of the PA). However, it is desirable to maintain phase coherency between symbols (by keeping the power approximately constant over all PUSCH symbols) to enable a receiver to efficiently and effectively recover the transmitted symbols.

The disclosure relates in some aspects to boosting the power of non-muted REs (or RBs, etc.) in a symbol that has at least one muted RE (or RB, etc.). In some examples, this boosting procedure may be referred to as energy per resource element (EPRE) boosting. In the example of FIG. 10, the REs with crosshatching (e.g., RE 1016) may be the power boosted REs. FIG. 10 may thus illustrate an example of EPRE boosting of PUSCH REs when there is an overlap with an UL muting pattern.

If a UE is configured with an UL-muting pattern that overlaps with an UL transmission, the power of any non-muted REs in a symbol with at least one muted RE may be boosted. For example, the EPRE of non-DMRS symbols may be boosted to maintain a constant per-symbol power over the UL transmission. In some examples, EPRE boosting as taught herein is not applied to DMRS symbols since DMRS power boosting (e.g., as defined by TS 38.211 Section 7.4.1.1) may be used for DMRS symbols.

In a first example, the EPRE boosting is implicitly done by the UE when an UL-muting pattern is activated. In this case, there is no need for an explicit indication by a network entity. Here, the power boosting value may be implicitly determined by the UE to ensure constant power across the symbols. For example, the UE may determine the total power P of a symbol S1 that is adjacent to the symbol S2 subject to muting, determine the number of muted REs in S2, and calculate the power boost factor for each non-muted RE in S2 so that the total power of the non-muted REs in S2 equals the total power P in S1. For example, if half of the REs of S2 are muted, then without power boosting, the total power of S2 would be half (3 dB lower) than the total power P of S1. In this case, the power of each non-muted RE of S2 should be boosted by 3 dB.

In a second example, the EPRE boosting may be included as part of an RRC configuration. For example, the EPRE boosting may be included as part of an RRC configuration for an UL channel (e.g., in PUSCH config). In some aspects, this may allow flexibility in determining which UL channel needs EPRE boosting

In a third example, the UL muting pattern indicates whether the UL muting pattern requires the UE to use EPRE boosting on the UL if a transmission overlaps with the UL muting pattern. In some aspects, this may tie the boosting to the type of muting pattern. For example, some UL muting patterns may have negligible impact on UL power (e.g., depending on how many REs/RBs are muted). Thus, power boosting might not be indicated for such UL muting patterns.

In a fourth example, the EPRE boosting value may be explicitly signaled to the UE. For example, the EPRE boosting value may be explicitly signaled to the UE as part of an RRC configuration (e.g., for UL-channel config or UL-muting pattern config).

As another example of explicit signaling, a UE may be configured with a list of allowed EPRE boosting values. In some examples, the list may be defined by a wireless communication standard (e.g., a 3GPP technical specification (TS)). In some examples, a UE may receive the list via RRC signaling or some other type of signaling.

For example, an RRC configuration may include a list of allowed power boosting values {p0, . . . , p3}. In some examples, a particular value (e.g., p0) in the list may depend on the type of PUSCH transmission (e.g., a fully coherent transmission, a partially-coherent transmission, or a non-coherent transmission). In some aspects, this approach may be similar to phase tracking reference signal (PTRS) power boosting where a set of ptrs-Power parameters are configured by a PTRS-UplinkConfig configuration as set forth in TS 38.214, section 6.1.

A UE that is configured with such a list may be sent an index that identifies which EPRE boosting value from the list is to be used. In some examples, Layer 1 (L1) or Layer 2 (L2) signaling may be used to identify a value from the list. For example, a DCI (e.g., a DCI that activates the PUSCH) may indicate which power boosting value is to be used (e.g., by including an index in the DCI). As another example, a MAC-CE (e.g., a MAC-CE that activates or deactivates UL-power boosting for one or more UL channels) may indicate which power boosting value is to be used (e.g., by including an index in the MAC-CE).

In a fifth example, UL EPRE boosting may be defined for certain UL channels. For example, UL EPRE boosting may be used only for channels where the impact of power imbalance across UL symbols has a noticeable (or otherwise sufficiently significant) impact on the channel performance.

In some examples, UL EPRE boosting may be defined for PUSCH or PUCCH long format where the length of the UL transmission exceeds a certain number of symbols. For example, UL EPRE boosting may be applicable for any UL transmission of more than 2 symbols.

In some examples, UL EPRE boosting is used for OFDM based waveforms. For example, UL EPRE boosting may be using for PUSCH (CP-OFDM, DFT-s-OFDM) and/or PUCCH formats 2, 3, and 4.

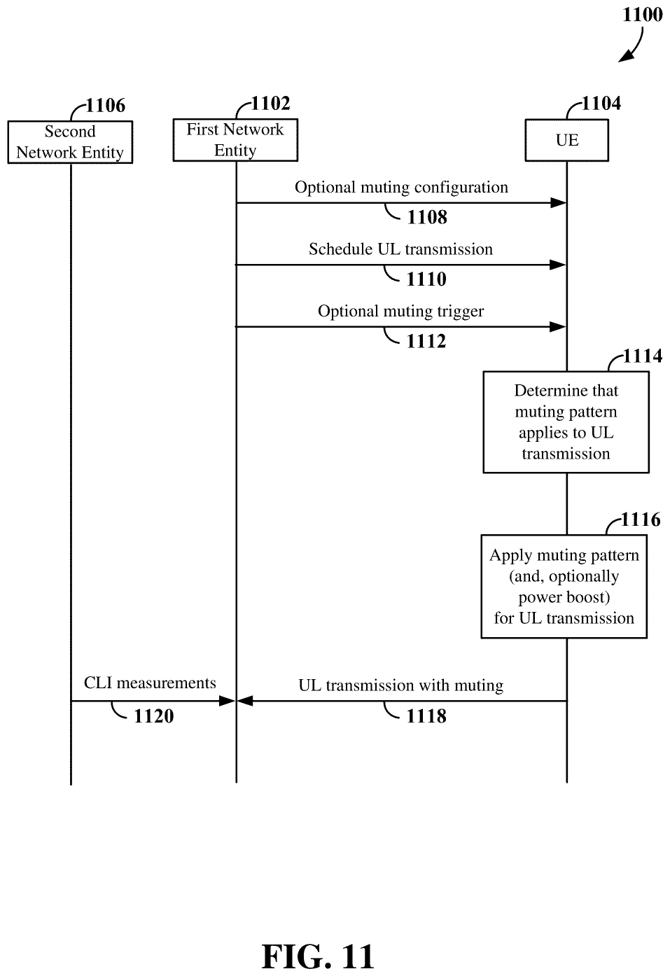

FIG. 11 is a signaling diagram 1100 illustrating an example of signaling associated with resource element muting in a wireless communication system including a first network entity 1102, a UE 1104, and a second network entity 1106. In some examples, the first network entity 1102 and the second network entity 1106 may correspond to any of the network entities, base stations, CUs, DUs, RUs, or scheduling entities shown in any of FIGS. 1, 2, 3, 5, 9, and 14. In some examples, the UE 1104 may correspond to any of the UEs or scheduled entities shown in any of FIGS. 1, 2, 3, 5, 9, and 12.

At optional #1108 of FIG. 11, the first network entity 1102 may send a muting configuration to the UE 1104. In some examples, the muting configuration may be included in an RRC configuration (e.g., a PUSCH config). In some examples, the muting configuration may be a dedicated message (e.g., a dedicated RRC muting configuration). The muting configuration may be sent in other ways in other examples.

In some examples, the muting configuration may indicate a muting pattern. For example, the muting pattern may take the form of an offset (e.g., relative to the beginning of a slot or frame) and a repetition or periodicity (e.g., indicating whether every second, third, fourth, etc., RE or RB is to be muted). In some examples, the muting pattern may specify which REs or RBs in a symbol (e.g., first, third, fourth, etc.) are to be muted.

In some examples, the muting configuration may indicate whether power boosting is applicable to a muting pattern. For example, the muting configuration may include one or more power boost factors (e.g., a specific power boost value or a list of power boost values). In some examples, power boosting information may be sent via a DCI or a MAC-CE.

At #1110, the first network entity 1102 schedules an UL transmission for the UE 1104. For example, the first network entity 1102 may send a DCI that includes PUSCH scheduling information to the UE 1104.

At optional #1112, the first network entity 1102 may send a muting trigger to the UE 1104. In some examples, the muting trigger may indicate that UL muting is to be applied to the transmission scheduled at #1110. In some examples, the muting trigger may activate UL muting (e.g., UL muting is to be applied by the UE 1104 until the UL muting is deactivated). In some examples, the muting trigger may be included in a DCI (e.g., transmitted at #1110). In some examples, the muting trigger may be included in a MAC-CE. For example, the first network entity 1102 may send a first MAC-CE to activate muting and subsequently send a second MAC-CE to deactivate the muting.

At #1114, the UE 1104 may determine that a muting pattern applies to the UL transmission scheduled at #1110. For example, the UE 1104 may determine that one or more symbols subject to muting (as indicated by the muting pattern) correspond to one or more symbols of a scheduled PUSCH transmission (e.g., that is scheduled on an SBFD slot).

As discussed above, in some examples, the muting pattern (or a list of muting patterns) may be received by the UE 1104 (e.g., from the first network entity 1102). In some examples, the muting pattern (or a list of muting patterns) may be specified by a wireless communication standard.

At #1116, the UE 1104 applies the muting pattern to the UL transmission. For example, the UE 1104 may determine that certain REs or RBs in certain symbols (e.g., as shown in FIG. 10) are to be muted.

In addition, the UE 1104 may determine whether power boosting is to be used in conjunction with the UL muting. For example, the UE 1104 may determine that certain REs or RBs in certain symbols (e.g., as shown in FIG. 10) are to be power boosted. In this case, the UE 1104 may determine the power boost factor to be applied to each of these symbols. As discussed herein, this may involve the UE 1104 calculating the power boost factor (e.g., to ensure that the power of adjacent symbols is approximately the same) in some examples. In other examples, the UE 1104 may receive an indication of the power boost factor to be used (e.g., the UE 1104 may receive a specific power boost value or an index from the first network entity 1102).

The UE 1104 may determine whether power boosting is to be used in various ways in different examples. In some examples, the UE 1104 may determine whether the particular muting pattern requires power boosting. For example, if fewer than a threshold number (e.g., two, three, etc.) of REs or RBs are to be muted, power boosting might not be needed. In some examples, the UE 1104 may determine whether the type of channel scheduled at #1110 is subject to power boosting. For example, power boosting might not be needed for non-long format PUSCH or PUCCH transmissions or for transmissions of non-OFDM waveforms. In some examples, the first network entity 1102 may send a first MAC-CE to activate power boosting and subsequently send a second MAC-CE to deactivate the power boosting.

At #1118, the UE 1104 applies the muting pattern to the UL transmission. In addition, the UE 1104 may apply power boosting, if appropriate.

As discussed above, in some examples, the power boost factor (or a list of power boost factors) may be received by the UE 1104 (e.g., from the first network entity 1102). In some examples, the power boost factor (or a list of power boost factors) may be specified by a wireless communication standard. In examples where the UE 1104 is configured with a list of power boost factors, the first network entity 1102 may send to the UE 1104 an index that indicates the specific power boost factor from the list that is to be used by the UE 1104.

At #1120, concurrent with the UL transmission at #1120, the first network entity 1102 may conduct CLI-related measurements. For example, during the REs or RBs that have been muted, the first network entity 1102 may measure the corresponding channel (e.g., to measure the CLI from the second network entity 1106).

FIG. 12 is a block diagram illustrating an example of a hardware implementation for an apparatus 1200 employing a processing system 1214. For example, the apparatus 1200 may be a device configured to wirelessly communicate in a network as discussed in any of FIGS. 1-11. In some implementations, the apparatus 1200 may correspond to any of the UEs, sidelink devices, D2D devices, or scheduled entities shown in any of FIGS. 1, 2, 3, 5, 9, and 11.

In accordance with various aspects of the disclosure, an element, or any portion of an element, or any combination of elements may be implemented with the processing system 1214. The processing system 1214 may include one or more processors (referred to herein as the processor 1204, for convenience). Examples of processors 1204 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 1200 may be configured to perform any one or more of the functions described herein. That is, the processor 1204, as utilized in an apparatus 1200, may be used to implement any one or more of the processes and procedures described herein.

The processor 1204 may in some instances be implemented via a baseband or modem chip and in other implementations, the processor 1204 may itself include a number of devices distinct and different from a baseband or modem chip (e.g., in such scenarios these devices may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1214 may be implemented with a bus architecture, represented generally by the bus 1202. The bus 1202 may include any number of interconnecting buses and bridges depending on the specific application of the processing system 1214 and the overall design constraints. The bus 1202 communicatively couples together various circuits including one or more processors (represented generally by the processor 1204), one or more memories (referred to herein as the memory 1205, for convenience), and one or more computer-readable media (represented generally by the computer-readable medium 1206). The bus 1202 may also link various other circuits such as timing sources, peripherals, voltage regulators, and power management circuits, which are well known in the art, and therefore, will not be described any further. A bus interface 1208 provides an interface between the bus 1202, a transceiver 1210 and an antenna array 1220 and between the bus 1202 and an interface 1230. The transceiver 1210 provides a communication interface or means for communicating with various other apparatus over a wireless transmission medium. The interface 1230 provides a communication interface or means of communicating with various other apparatuses and devices (e.g., other devices housed within the same apparatus as the apparatus 1200 or other external apparatuses) over an internal bus or external transmission medium, such as an Ethernet cable. Depending upon the nature of the apparatus, the interface 1230 may include a user interface (e.g., keypad, display, speaker, microphone, joystick). Of course, such a user interface is optional, and may be omitted in some examples, such as an IoT device.

The processor 1204 is responsible for managing the bus 1202 and general processing, including the execution of software stored on the computer-readable medium 1206. The software, when executed by the processor 1204, causes the processing system 1214 to perform the various functions described below for any particular apparatus. The computer-readable medium 1206 and the memory 1205 may also be used for storing data that is manipulated by the processor 1204 when executing software. For example, the memory 1205 may store muting information 1215 (e.g., a muting pattern) used by the processor 1204 for the communication operations described herein.

One or more processors 1204 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1206.

The computer-readable medium 1206 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1206 may reside in the processing system 1214, external to the processing system 1214, or distributed across multiple entities including the processing system 1214. The computer-readable medium 1206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

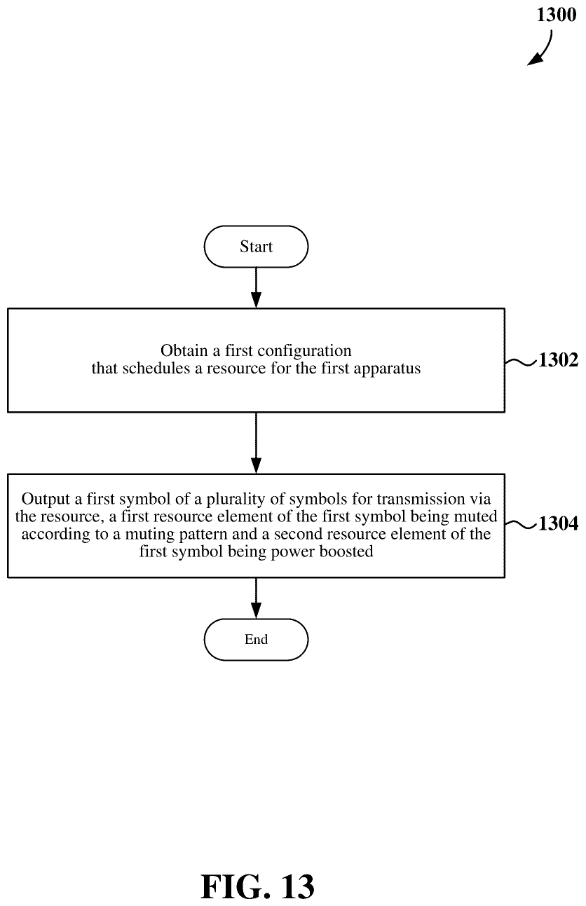

The apparatus 1200 may be configured to perform any one or more of the operations described herein (e.g., as described above in conjunction with FIGS. 1-11, and as described below in conjunction with FIG. 13). In some aspects of the disclosure, the processor 1204, as utilized in the apparatus 1200, may include circuitry configured for various functions.

In some aspects of the disclosure, the processor 1204 may include communication and processing circuitry 1241. The communication and processing circuitry 1241 may be configured to communicate with a network entity and/or other wireless devices. The communication and processing circuitry 1241 may include one or more hardware components that provide the physical structure that performs various processes related to communication (e.g., signal reception and/or signal transmission) as described herein. The communication and processing circuitry 1241 may further include one or more hardware components that provide the physical structure that performs various processes related to signal processing (e.g., processing a received signal and/or processing a signal for transmission) as described herein. The communication and processing circuitry 1241 may further be configured to execute communication and processing software 1251 included on the computer-readable medium 1206 to implement one or more functions described herein.

The communication and processing circuitry 1241 may further be configured to send or receive an indication. For example, the indication may be included in a MAC-CE carried in a Uu PUSCH, Uu PDSCH, or a PSCCH, or included in a Uu RRC message or an SL RRC message. The communication and processing circuitry 1241 may further be configured to send a scheduling request an uplink grant or a sidelink grant.

In some implementations where the communication involves receiving information, the communication and processing circuitry 1241 may obtain information from a component of the apparatus 1200 (e.g., from the transceiver 1210 that receives the information via radio frequency signaling or some other type of signaling suitable for the applicable communication medium), process (e.g., decode) the information, and output the processed information. For example, the communication and processing circuitry 1241 may output the information to another component of the processor 1204, to the memory 1205, or to the bus interface 1208. In some examples, the communication and processing circuitry 1241 may receive one or more of signals, messages, other information, or any combination thereof. In some examples, the communication and processing circuitry 1241 may receive information via one or more channels. In some examples, the communication and processing circuitry 1241 may receive one or more of signals, messages, SCIs, feedback, other information, or any combination thereof. In some examples, the communication and processing circuitry 1241 may receive information via one or more of a PSCCH, a PSSCH, a PSFCH, some other type of channel, or any combination thereof. In some examples, the communication and processing circuitry 1241 and/or the transceiver 1210 may include functionality for a means for receiving (e.g., means for receiving a downlink transmission, means for receiving a configuration, etc.). In some examples, the communication and processing circuitry 1241 may include functionality for a means for decoding. In some examples, the communication and processing circuitry 1241 may include functionality for a means for receiving information from a network entity.

In some implementations where the communication involves sending (e.g., transmitting) information, the communication and processing circuitry 1241 may obtain information (e.g., from another component of the processor 1204, the memory 1205, or the bus interface 1208), process (e.g., encode) the information, and output the processed information. For example, the communication and processing circuitry 1241 may output the information to the transceiver 1210 (e.g., that transmits the information via radio frequency signaling or some other type of signaling suitable for the applicable communication medium). In some examples, the communication and processing circuitry 1241 may send one or more of signals, messages, other information, or any combination thereof. In some examples, the communication and processing circuitry 1241 may send information via one or more channels. In some examples, the communication and processing circuitry 1241 may send one or more of signals, messages, SCIs, feedback, other information, or any combination thereof. In some examples, the communication and processing circuitry 1241 may send information via one or more of a PSCCH, a PSSCH, a PSFCH, some other type of channel, or any combination thereof. In some examples, the communication and processing circuitry 1241 and/or the transceiver 1210 may include functionality for a means for transmitting (e.g., means for transmitting an uplink transmission, means for transmitting a symbol, etc.). In some examples, the communication and processing circuitry 1241 may include functionality for a means for encoding. In some examples, the communication and processing circuitry 1241 may include functionality for a means for transmitting information to a network entity.

The processor 1204 may include muting processing circuitry 1242 configured to perform muting processing-related operations as discussed herein (e.g., one or more of the operations described above in conjunction with FIGS. 1-11). The muting processing circuitry 1242 may be configured to execute muting processing software 1252 included on the computer-readable medium 1206 to implement one or more functions described herein.

The muting processing circuitry 1242 may include functionality for a means for obtaining (e.g., as described above in conjunction with FIGS. 1-11). For example, the muting processing circuitry 1242 may obtain (e.g., receive) information (e.g., a configuration, a DCI, etc.) from a network entity (e.g., via a PDCCH, a PDSCH, etc.). As another example, the muting processing circuitry 1242 may obtain (e.g., receive) a configuration that includes a muting pattern. As a further example, the muting processing circuitry 1242 may obtain (e.g., receive) a configuration that includes an indication of a power boost factor and/or a configuration that includes a list of power boost factors and/or a configuration that includes an indication of whether power boosting is to be used with a muting pattern. As an additional example, the muting processing circuitry 1242 may obtain (e.g., receive) an indication to activate a muting pattern. As still another example, the muting processing circuitry 1242 may obtain (e.g., receive) an index that maps to a specific power boost factor within a list of power boost factors. As another example, the muting processing circuitry 1242 may obtain (e.g., receive) a DCI or MAC-CE (e.g., that includes an index that maps to a specific power boost factor).

The muting processing circuitry 1242 may include functionality for a means for applying (e.g., as described above in conjunction with FIGS. 1-11). For example, the muting processing circuitry 1242 may apply a muting pattern to a resource element of a symbol (e.g., so that a transmission is not conducted on that resource element).

The muting processing circuitry 1242 may include functionality for a means for processing a message (e.g., as described above in conjunction with FIGS. 1-11). For example, the muting processing circuitry 1242 may decode a DCI based on a radio network temporary identifier (RNTI), a search space, and/or other information. In various examples, the muting processing circuitry 1242 may be configured to receive and/or decode a PDSCH, a PDCCH, a PUSCH, a PUCCH, a PSSCH, a PSCCH, an SRS, a RACH, or other signaling.

The muting processing circuitry 1242 may include functionality for a means for outputting (e.g., as described above in conjunction with FIGS. 1-11). For example, the muting processing circuitry 1242 may output a signal subject to muting (e.g., to a network entity, a UE, etc.).

The processor 1204 may include power boosting processing circuitry 1243 configured to perform power boosting processing-related operations as discussed herein (e.g., one or more of the operations described above in conjunction with FIGS. 1-11). The power boosting processing circuitry 1243 may be configured to execute power boosting processing software 1253 included on the computer-readable medium 1206 to implement one or more functions described herein.

The power boosting processing circuitry 1243 may include functionality for a means for power boosting (e.g., as described above in conjunction with FIGS. 1-11). For example, the power boosting processing circuitry 1243 may boost the power of an RE to achieve a target power level across a symbol. As another example, the power boosting processing circuitry 1243 may boost the power of an RE based on (e.g., boost the power of the RE by) a power boost factor.

The power boosting processing circuitry 1243 may include functionality for a means for obtaining (e.g., as described above in conjunction with FIGS. 1-11). For example, the power boosting processing circuitry 1243 may obtain (e.g., receive) a MAC-CE that activates or deactivates power boosting for at least one channel.

The power boosting processing circuitry 1243 may include functionality for a means for performing a power boosting processing operation (e.g., as described above in conjunction with FIGS. 1-11). For example, the power boosting processing circuitry 1243 may determine how much to boost the power of a non-muted RE in a symbol. In some examples, the power boosting processing circuitry 1243 may include functionality for a means for selecting a power boost factor. For example, the power boosting processing circuitry 1243 may select a first power boost factor from a list of power boost factors. In some examples, the power boosting processing circuitry 1243 may include functionality for a means for calculating a power boost factor (e.g. 3 dB, etc.). For example, the power boosting processing circuitry 1243 may calculate a power boost factor according to the target power level and a quantity of resources elements of the first symbol that are muted. In some examples, the power boosting processing circuitry 1243 may include functionality for a means for multiplying. For example, the power boosting processing circuitry 1243 may multiply a power level for a resource element by a power boost factor.

FIG. 13 is a flow chart illustrating an example method 1300 for communication in accordance with some aspects of the present disclosure. As described below, some or all illustrated features may be omitted in a particular implementation within the scope of the present disclosure, and some illustrated features may not be required for implementation of all examples. In some examples, the method 1300 (e.g., a method for wireless communication) may be carried out by the apparatus 1200 illustrated in FIG. 12, the apparatus 502 illustrated in FIG. 5, or a wireless node. In some examples, the method 1300 may be carried out by any suitable apparatus or means for carrying out the functions or algorithm described below.

At block 1302, a first apparatus may obtain a first configuration that schedules a resource for the first apparatus. In some examples, the muting processing circuitry 1242, shown and described in FIG. 12, may provide a means to obtain a first configuration that schedules a resource for the first apparatus. In some examples, the muting processing circuitry 1242 together with the communication and processing circuitry 1241 and the transceiver 1210, shown and described in FIG. 12, may provide a means to obtain a first configuration that schedules a resource for the first apparatus. In some examples, the communication and processing circuitry 1241 and/or the transceiver 1210, shown and described in FIG. 12, may provide a means to obtain a first configuration that schedules a resource for the first apparatus.

At block 1304, the first apparatus may output a first symbol of a plurality of symbols for transmission via the resource, a first resource element of the first symbol being muted according to a muting pattern and a second resource element of the first symbol being power boosted. In some examples, the muting processing circuitry 1242 and/or the power boosting processing circuitry 1243, shown and described in FIG. 12, may provide a means to output a first symbol of a plurality of symbols for transmission via the resource, a first resource element of the first symbol being muted according to a muting pattern and a second resource element of the first symbol being power boosted. In some examples, the muting processing circuitry 1242 and/or the power boosting processing circuitry 1243, together with the communication and processing circuitry 1241 and the transceiver 1210, shown and described in FIG. 12, may provide a means to output a first symbol of a plurality of symbols for transmission via the resource, a first resource element of the first symbol being muted according to a muting pattern and a second resource element of the first symbol being power boosted. In some examples, the communication and processing circuitry 1241 and/or the transceiver 1210, shown and described in FIG. 20, may provide a means to output a first symbol of a plurality of symbols for transmission via the resource, a first resource element of the first symbol being muted according to a muting pattern and a second resource element of the first symbol being power boosted.

In some examples, the resource is a subset of a sub-band full-duplex resource. In some examples, the plurality of symbols may include orthogonal frequency division multiplexed symbols.

In some examples, the muting pattern may include an uplink muting pattern. In some examples, the transmission via the resource may include an uplink transmission via a physical uplink shared channel or a physical uplink control channel.

In some examples, the first apparatus may obtain a second configuration that includes the muting pattern.

In some examples, the first apparatus may apply the muting pattern to the first resource element of the first symbol if the muting pattern overlaps with an uplink transmission scheduled by the first configuration.

In some examples, the first apparatus may power boost the second resource element to achieve a target power level across all resource elements of the first symbol. In some examples, the first apparatus may calculate a power boost factor according to the target power level and a quantity of resources elements of the first symbol that are muted. In some examples, the first apparatus may power boost the second resource element by the power boost factor. In some examples, power boosting the second resource element may include multiplying a power level for the second resource element by the power boost factor.

In some examples, the first apparatus may obtain an indication to activate the muting pattern. In some examples, the first apparatus may apply the muting pattern to the first resource element of the first symbol after the indication is obtained.

In some examples, the first apparatus may obtain a second configuration that includes an indication of a power boost factor. In some examples, the first apparatus may power boost the second resource element by the power boost factor. In some examples, the second configuration may include a radio resource control configuration message for an uplink channel.

In some examples, the indication of the power boost factor may include a specific power boost factor. In some examples, the indication of the power boost factor may include an index that maps to one power boost factor from a list of power boost factors.

In some examples, the first apparatus may obtain a second configuration that includes the muting pattern and an indication of whether power boosting is to be used with the muting pattern.

In some examples, the second configuration may include an indication of a power boost factor. In some examples, the first apparatus may power boost the second resource element by the power boost factor.

In some examples, the first apparatus may select a first power boost factor from a list of power boost factors. In some examples, the first apparatus may power boost the second resource element by the first power boost factor. In some examples, the selected first power boost factor corresponds to a transmission type of the transmission. In some examples, the first apparatus may obtain a second configuration that may include the list of power boost factors. In some examples, the list of power boost factors is specified by a wireless communication standard.

In some examples, the first apparatus may obtain an index that maps to a specific power boost factor within the list of power boost factors. In some examples, the selected first power boost factor corresponds to the specific power boost factor. In some examples, the first apparatus may obtain downlink control information (DCI) that activates a physical uplink shared channel transmission, where the DCI includes the index. In some examples, the first apparatus may obtain a medium access control-control element (MAC-CE) that activates or deactivates power boosting for at least one channel, where the MAC-CE includes the index.

In some examples, the first apparatus may apply the muting pattern to the first resource element of the first symbol if the transmission is associated with a channel of a particular type.

In some examples, the first apparatus may apply the muting pattern to the first resource element of the first symbol if the transmission is associated with an uplink transmission having a particular format or length. In some examples, the first apparatus may apply the muting pattern to the first resource element of the first symbol if the transmission is an uplink transmission employing an orthogonal frequency division multiplexing waveform.

In some examples (e.g., where the first apparatus is configured as a UE), the first apparatus may receive the first configuration and transmit the first symbol.

Referring again to FIG. 12, in one configuration, the first apparatus 1200 includes means for obtaining a first configuration that schedules a resource for the first apparatus, and means for outputting a first symbol of a plurality of symbols for transmission via the resource, a first resource element of the first symbol being muted according to a muting pattern and a second resource element of the first symbol being power boosted. In one aspect, the aforementioned means may be the processor 1204 shown in FIG. 12 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable medium 1206, or any other suitable apparatus or means described in any of FIGS. 1, 2, 3, 5, 9, 11, and 12, and utilizing, for example, the methods and/or algorithms described herein in relation to FIG. 13.

FIG. 14 is a conceptual diagram illustrating an example of a hardware implementation for an apparatus 1400 employing a processing system 1414. In some implementations, the apparatus 1400 may correspond to any of the network entities, CUs, DUs, RUs, base stations, or scheduling entities shown in any of FIGS. 1, 2, 3, 5, 9, and 11. In some implementations, the apparatus 1400 may correspond to any of the UEs or scheduled entities shown in any of FIGS. 1, 2, 3, 5, 9, 11, and 12 (e.g., to implement the techniques described herein in a peer-to-peer configuration in conjunction with the apparatus 2000, where the DCI referred to herein may be instead referred to as control information (CI)).

In accordance with various aspects of the disclosure, an element, or any portion of an element, or any combination of elements may be implemented with the processing system 1414. The processing system may include one or more processors (referred to herein as the processor 1404, for convenience). The processing system 1414 may be substantially the same as the processing system 1214 illustrated in FIG. 12, including a bus interface 1408, a bus 1402, one or more memories (referred to herein as the memory 1405, for convenience), a processor 1404, a computer-readable medium 1406, a transceiver 1410, and an antenna array 1420. The memory 1405 may store muting information 1415 (e.g., a muting pattern) used by the processor 1404 in cooperation with the transceiver 1410 for communication operations as described herein. Furthermore, the apparatus 1400 may include an interface 1430 (e.g., a network interface) that provides a means for communicating with at least one other apparatus within a core network and with at least one radio access network.

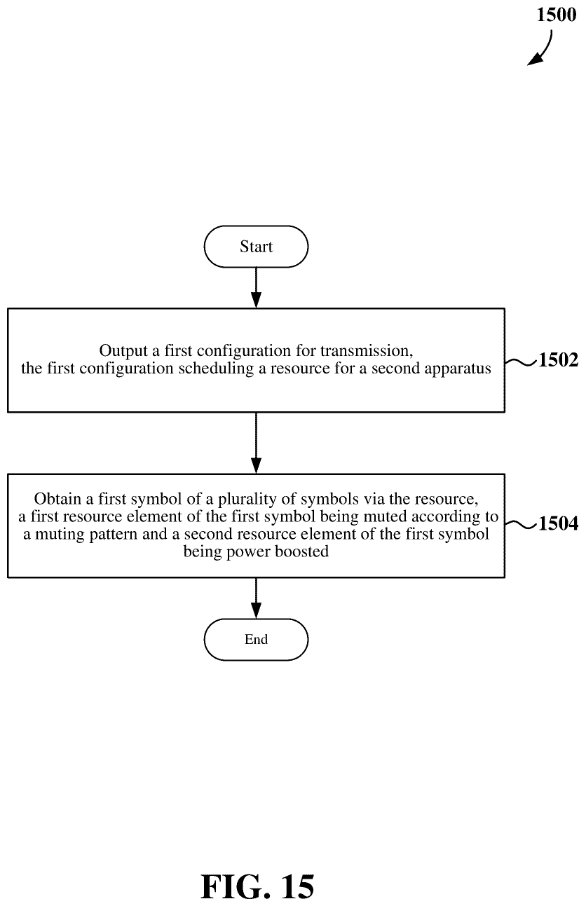

The apparatus 1400 may be configured to perform any one or more of the operations described herein (e.g., as described above in conjunction with FIGS. 1-11 and as described below in conjunction with FIG. 15). In some aspects of the disclosure, the processor 1404, as utilized in the apparatus 1400, may include circuitry configured for various functions.

The processor 1404 may be configured to generate, schedule, and modify a resource assignment or grant of time-frequency resources (e.g., a set of one or more resource elements). For example, the processor 1404 may schedule time-frequency resources within a plurality of time division duplex (TDD) and/or frequency division duplex (FDD) subframes, slots, and/or mini-slots to carry user data traffic and/or control information to and/or from multiple UEs.

The processor 1404 may be configured to schedule resources for the transmission of sidelink signals, downlink signals, or uplink signals. The processor 1404 may be configured to schedule resources for control information (e.g., DCI) operations.

In some aspects of the disclosure, the processor 1404 may include communication and processing circuitry 1441. The communication and processing circuitry 1441 may be configured to communicate with UEs and/or network entities. The communication and processing circuitry 1441 may include one or more hardware components that provide the physical structure that performs various processes related to communication (e.g., signal reception and/or signal transmission) as described herein. The communication and processing circuitry 1441 may further include one or more hardware components that provide the physical structure that performs various processes related to signal processing (e.g., processing a received signal and/or processing a signal for transmission) as described herein. The communication and processing circuitry 1441 may further be configured to execute communication and processing software 1451 included on the computer-readable medium 1406 to implement one or more functions described herein.

In some implementations wherein the communication involves receiving information, the communication and processing circuitry 1441 may obtain information from a component of the apparatus 1400 (e.g., from the transceiver 1410 that receives the information via radio frequency signaling or some other type of signaling suitable for the applicable communication medium), process (e.g., decode) the information, and output the processed information. For example, the communication and processing circuitry 1441 may output the information to another component of the processor 1404, to the memory 1405, or to the bus interface 1408. In some examples, the communication and processing circuitry 1441 may receive one or more of signals, messages, other information, or any combination thereof. In some examples, the communication and processing circuitry 1441 may receive information via one or more channels. In some examples, the communication and processing circuitry 1441 and/or the transceiver 1410 may include functionality for a means for receiving (e.g., means for receiving an uplink transmission, means for receiving a symbol, etc.). In some examples, the communication and processing circuitry 1441 may include functionality for a means for decoding. In some examples, the communication and processing circuitry 1441 may include functionality for a means for receiving signal measurement information from a UE.

In some implementations wherein the communication involves sending (e.g., transmitting) information, the communication and processing circuitry 1441 may obtain information (e.g., from another component of the processor 1404, the memory 1405, or the bus interface 1408), process (e.g., encode) the information, and output the processed information. For example, the communication and processing circuitry 1441 may output the information to the transceiver 1410 (e.g., that transmits the information via radio frequency signaling or some other type of signaling suitable for the applicable communication medium). In some examples, the communication and processing circuitry 1441 may send one or more of signals, messages, other information, or any combination thereof. In some examples, the communication and processing circuitry 1441 may send information via one or more channels. In some examples, the communication and processing circuitry 1441 and/or the transceiver 1410 may include functionality for a means for transmitting (e.g., means for transmitting a downlink transmission, means for transmitting a configuration, etc.). In some examples, the communication and processing circuitry 1441 may include functionality for a means for encoding. In some examples, the communication and processing circuitry 1441 may include functionality for a means for transmitting information to a UE.

The processor 1404 may include muting configuration circuitry 1442 configured to perform muting configuration-related operations as discussed herein (e.g., one or more of the operations described above in conjunction with FIGS. 1-11). The muting configuration circuitry 1442 may be configured to execute muting configuration software 1452 included on the computer-readable medium 1406 to implement one or more functions described herein.

The muting configuration circuitry 1442 may include functionality for a means for outputting (e.g., as described above in conjunction with FIGS. 1-11). For example, the muting configuration circuitry 1442 may output (e.g., send) a configuration to a UE (e.g., via a PDSCH). A configuration may include one or more of a muting pattern, a power boost factor, an indication of a power boost factor, a list of power boost factors, or other information. As another example, the muting configuration circuitry 1442 may output (e.g., send) an indication. An indication may be one or more of an indication to activate a muting pattern, an indication of whether power boosting is to be used with a muting pattern, an indication of a power boost factor, or some other type of information. As a further example, the muting configuration circuitry 1442 may output (e.g., send) an index that maps to a specific power boost factor within a list of power boost factors. As an additional example, the muting configuration circuitry 1442 may output (e.g., send) a DCI (e.g., that includes an index that maps to a specific power boost factor). As another example, the muting configuration circuitry 1442 may output (e.g., send) a MAC-CE (e.g., that activates or deactivates power boosting for at least one channel and/or that includes an index that maps to a specific power boost factor).

The muting configuration circuitry 1442 may include functionality for a means for generating a message (e.g., as described above in conjunction with FIGS. 1-11). For example, the muting configuration circuitry 1442 may generate a DCI based on an RNTI and/or other information.

The muting configuration circuitry 1442 may include functionality for a means for obtaining (e.g., as described above in conjunction with FIGS. 1-11). For example, the muting configuration circuitry 1442 may obtain a symbol from a UE (e.g., via a PUSCH).

The processor 1404 may include CLI processing circuitry 1443 configured to perform CLI processing-related operations as discussed herein (e.g., one or more of the operations described above in conjunction with FIGS. 11-11). The CLI processing circuitry 1443 may be configured to execute CLI processing software 1453 included on the computer-readable medium 1406 to implement one or more functions described herein.

The CLI processing circuitry 1443 may include functionality for a means for outputting a message (e.g., as described above in conjunction with FIGS. 1-11). For example, the CLI processing circuitry 1443 may output a message (e.g., a DCI, a groupcast message, etc.) for transmission to at least one UE (e.g., via a PDCCH, a PDSCH, etc.) or to at least one network entity.

The CLI processing circuitry 1443 may include functionality for a means for measuring CLI (e.g., as described above in conjunction with FIGS. 1-11). For example, the CLI processing circuitry 1443 may monitor a channel and calculate interference based on the energy received on the channel.

In some examples, the apparatus 1400 shown and described above in connection with FIG. 14 may be a disaggregated base station. For example, the apparatus 1400 shown in FIG. 14 may include the CU and optionally one or more DUs/RUs of the disaggregated base station. Other DUs/RUs associated with the apparatus 1400 may be distributed throughout the network. In some examples, the DUs/RUs may correspond to TRPs associated with the network entity. In some examples, the CU and/or DU/RU of the disaggregated base station (e.g., within the apparatus 1400) may generate muting information and send the muting information to a UE.

FIG. 15 is a flow chart illustrating an example method 1500 for wireless communication in accordance with some aspects of the present disclosure. As described below, some or all illustrated features may be omitted in a particular implementation within the scope of the present disclosure, and some illustrated features may not be required for implementation of all examples. In some examples, the method 1500 (e.g., a method for wireless communication) may be carried out by the apparatus 1400 illustrated in FIG. 14, the apparatus 502 illustrated in FIG. 5, or a wireless node. In some examples, the method 1500 may be carried out by any suitable apparatus or means for carrying out the functions or algorithm described below.

At block 1502, a first apparatus may output a first configuration for transmission, the first configuration scheduling a resource for a second apparatus. In some examples, the muting configuration circuitry 1442, shown and described in FIG. 14, may provide a means to output a first configuration for transmission, the first configuration scheduling a resource for a second apparatus. In some examples, the muting configuration circuitry 1442 together with the communication and processing circuitry 1441 and the transceiver 1410, shown and described in FIG. 14, may provide a means to output a first configuration for transmission, the first configuration scheduling a resource for a second apparatus. In some examples, the communication and processing circuitry 1441 and/or the transceiver 1410, shown and described in FIG. 14, may provide a means to output a first configuration for transmission, the first configuration scheduling a resource for a second apparatus.

At block 1504, the first apparatus may obtain a first symbol of a plurality of symbols via the resource, a first resource element of the first symbol being muted according to a muting pattern and a second resource element of the first symbol being power boosted. In some examples, the muting configuration circuitry 1442, shown and described in FIG. 14, may provide a means to obtain a first symbol of a plurality of symbols via the resource, a first resource element of the first symbol being muted according to a muting pattern and a second resource element of the first symbol being power boosted. In some examples, the muting configuration circuitry 1442 together with the communication and processing circuitry 1441 and the transceiver 1410, shown and described in FIG. 14, may provide a means to obtain a first symbol of a plurality of symbols via the resource, a first resource element of the first symbol being muted according to a muting pattern and a second resource element of the first symbol being power boosted. In some examples, the communication and processing circuitry 1441 and/or the transceiver 1410, shown and described in FIG. 14, may provide a means to obtain a first symbol of a plurality of symbols via the resource, a first resource element of the first symbol being muted according to a muting pattern and a second resource element of the first symbol being power boosted.

In some examples, the resource is a subset of a sub-band full-duplex resource. In some examples, the plurality of symbols may include orthogonal frequency division multiplexed symbols.

In some examples, the first apparatus may measure cross-link interference using the first resource element. In some examples, the cross-link interference may be associated with transmissions by a network entity.

In some examples, the first apparatus may output a second configuration for transmission. In some examples, the second configuration may include the muting pattern.

In some examples, the first apparatus may output a second configuration for transmission. In some examples, the second configuration may include a power boost factor associated with the muting pattern.

In some examples, the first apparatus may output an indication to activate the muting pattern.

In some examples, the muting pattern may include an uplink muting pattern. In some examples, the first symbol is part of an uplink transmission on a physical uplink shared channel. In some examples, the first symbol is part of an uplink transmission on a physical uplink control channel.

In some examples, the first apparatus may output, for transmission, an indication to activate the muting pattern.

In some examples, the first apparatus may output, for transmission, a second configuration that includes an indication of a power boost factor. In some examples, the second configuration may include a radio resource control configuration message for an uplink channel.

In some examples, the indication of the power boost factor may include a specific power boost factor. In some examples, the indication of the power boost factor may include an index that maps to one power boost factor from a list of power boost factors.

In some examples, the first apparatus may output, for transmission, a second configuration including the muting pattern and an indication of whether power boosting is to be used with the muting pattern. In some examples, the second configuration may include an indication of a power boost factor.

In some examples, the first apparatus may output, for transmission, a second configuration that includes a list of power boost factors. In some examples, the first apparatus may output, for transmission, an index that maps to a specific power boost factor within the list of power boost factors.

In some examples, the first apparatus may output, for transmission, downlink control information (DCI) that activates a physical uplink shared channel transmission, where the DCI includes the index. In some examples, the first apparatus may output, for transmission, a medium access control-control element (MAC-CE) that activates or deactivates power boosting for at least one channel, where the MAC-CE includes the index.

In some examples (e.g., where the first apparatus is configured as a network entity), the first apparatus may transmit the first configuration and receive the first symbol.

Referring again to FIG. 14, in one configuration, the first apparatus 1400 includes means for outputting a first configuration for transmission, the first configuration scheduling a resource for a second apparatus, and means for obtaining a first symbol of a plurality of symbols via the resource, a first resource element of the first symbol being muted according to a muting pattern and a second resource element of the first symbol being power boosted. In one aspect, the aforementioned means may be the processor 1404 shown in FIG. 14 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1404 is merely provided as an example, and other means for carrying out the described functions may be included within various aspects of the present disclosure, including but not limited to the instructions stored in the computer-readable medium 1406, or any other suitable apparatus or means described in any of FIGS. 1, 2, 3, 5, 9, 11, and 14, and utilizing, for example, the methods and/or algorithms described herein in relation to FIG. 15.

The methods shown in FIGS. 13 and 15 may include additional aspects, such as any single aspect or any combination of aspects described below and/or in connection with one or more other processes described elsewhere herein. The following provides an overview of several aspects of the present disclosure.

Aspect 1: A method for communication at a first apparatus (e.g., a method for communication at a user equipment), the method comprising: obtaining a first configuration that schedules a resource for the first apparatus; and outputting a first symbol of a plurality of symbols for transmission via the resource, a first resource element of the first symbol being muted according to a muting pattern and a second resource element of the first symbol being power boosted.

Aspect 2: The method of aspect 1, wherein the resource is a subset of a sub-band full-duplex resource.

Aspect 3: The method of any of aspects 1 through 2, wherein at least one of: the muting pattern comprises an uplink muting pattern; or the transmission via the resource comprises an uplink transmission via a physical uplink shared channel or a physical uplink control channel.

Aspect 4: The method of any of aspects 1 through 3, further comprising: obtaining a second configuration comprising the muting pattern.

Aspect 5: The method of any of aspects 1 through 4, further comprising: applying the muting pattern to the first resource element of the first symbol if the muting pattern overlaps with an uplink transmission scheduled by the first configuration.

Aspect 6: The method of any of aspects 1 through 5, further comprising: power boosting the second resource element to achieve a target power level across all resource elements of the first symbol.

Aspect 7: The method of aspect 6, further comprising: calculating a power boost factor according to the target power level and a quantity of resources elements of the first symbol that are muted; wherein the power boost of the second resource element comprises multiplication of a power level for the second resource element by the power boost factor.

Aspect 8: The method of any of aspects 1 through 7, further comprising: obtaining an indication to activate the muting pattern; and applying the muting pattern to the first resource element of the first symbol after the indication is obtained.

Aspect 9: The method of any of aspects 1 through 8, further comprising: obtaining a second configuration comprising an indication of a power boost factor; and power boosting the second resource element by the power boost factor.

Aspect 10: The method of aspect 9, wherein the second configuration comprises a radio resource control configuration message for an uplink channel.

Aspect 11: The method of any of aspects 9 through 10, wherein the indication of the power boost factor comprises: a specific power boost factor; or an index that maps to one power boost factor from a list of power boost factors.

Aspect 12: The method of any of aspects 1 through 11, further comprising: obtaining a second configuration comprising the muting pattern and an indication of whether power boosting is to be used with the muting pattern.

Aspect 13: The method of aspect 12, wherein: the second configuration comprises an indication of a power boost factor; and the method further comprises power boosting the second resource element by the power boost factor.

Aspect 14: The method of any of aspects 1 through 13, further comprising: selecting a first power boost factor from a list of power boost factors; and power boosting the second resource element by the first power boost factor.

Aspect 15: The method of aspect 14, wherein the selected first power boost factor corresponds to a transmission type of the transmission.

Aspect 16: The method of aspect 14, further comprising: obtaining a second configuration that comprises the list of power boost factors.

Aspect 17: The method of aspect 14, wherein the list of power boost factors is specified by a wireless communication standard.

Aspect 18: The method of aspect 14, wherein: the method further comprises obtaining an index that maps to a specific power boost factor within the list of power boost factors; and the selected first power boost factor corresponds to the specific power boost factor.

Aspect 19: The method of aspect 18, further comprising: obtaining downlink control information (DCI) that activates a physical uplink shared channel transmission, the DCI comprising the index; or obtaining a medium access control-control element (MAC-CE) that activates or deactivates power boosting for at least one channel, the MAC-CE comprising the index.

Aspect 20: The method of any of aspects 1 through 19, further comprising: applying the muting pattern to the first resource element of the first symbol if the transmission is associated with a channel of a particular type.

Aspect 21: The method of any of aspects 1 through 20, further comprising: applying the muting pattern to the first resource element of the first symbol if at least one of: the transmission is associated with an uplink transmission having a particular format or length; or the transmission is an uplink transmission employing an orthogonal frequency division multiplexing waveform.

Aspect 22: The method of any of aspects 1 through 21, wherein the plurality of symbols comprise orthogonal frequency division multiplexed symbols.

Aspect 23: The method of any of aspects 1 through 22, further comprising: receiving the first configuration and transmitting the first symbol, wherein the first apparatus is configured as a UE.

Aspect 24: A method for communication at a first apparatus (e.g., a method for communication at a network entity), the method comprising: outputting a first configuration for transmission, the first configuration scheduling a resource for a second apparatus; and obtaining a first symbol of a plurality of symbols via the resource, a first resource element of the first symbol being muted according to a muting pattern and a second resource element of the first symbol being power boosted.

Aspect 25: The method of aspect 24, further comprising: measuring cross-link interference (measure cross-link interference) using the first resource element, the cross-link interference being associated with transmissions by a network entity.

Aspect 26: The method of any of aspects 24 through 25, further comprising: outputting a second configuration for transmission, the second configuration comprising the muting pattern.

Aspect 27: The method of any of aspects 24 through 26, further comprising: outputting a second configuration for transmission, the second configuration comprising a power boost factor associated with the muting pattern.

Aspect 28: The method of any of aspects 24 through 27, further comprising: outputting an indication to activate the muting pattern.

Aspect 29: The method of any of aspects 24 through 28, further comprising: transmitting the first configuration and receiving the first symbol, wherein the first apparatus is configured as a network entity.

Aspect 30: A user equipment, comprising: at least one transceiver; a memory comprising instructions; and one or more processors configured to execute the instructions and cause the network entity to perform a method in accordance with any one or more of aspects 1 through 22, wherein the at least one transceiver is configured to transmit the second indication.

Aspect 31: A first apparatus configured for communication comprising at least one means for performing any one or more of aspects 1 through 23.

Aspect 32: A non-transitory computer-readable medium storing computer-executable code, comprising code for causing a first apparatus to perform any one or more of aspects 1 through 23.

Aspect 33: A first apparatus, comprising: a memory comprising instructions; and one or more processors configured to execute the instructions and cause the first apparatus to perform a method in accordance with any one or more of aspects 1 through 22.

Aspect 34: A network entity, comprising: at least one transceiver; a memory comprising instructions; and one or more processors configured to execute the instructions and cause the network entity to perform a method in accordance with any one or more of aspects 24 through 28, wherein the at least one transceiver is configured to transmit the second indication.

Aspect 35: A first apparatus configured for communication comprising at least one means for performing any one or more of aspects 24 through 29.

Aspect 36: A non-transitory computer-readable medium storing computer-executable code, comprising code for causing a first apparatus to perform any one or more of aspects 24 through 29.

Aspect 37: A first apparatus, comprising: a memory comprising instructions; and one or more processors configured to execute the instructions and cause the first apparatus to perform a method in accordance with any one or more of aspects 24 through 28.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-15 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 3, 5, 9, 11, 12, and 14 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A first apparatus for communication, comprising:
a processing system configured to:
obtain a first configuration that schedules a resource for the first apparatus; and
output a first symbol of a plurality of symbols for transmission via the resource, a first resource element of the first symbol being muted according to a muting pattern and a second resource element of the first symbol being power boosted.

2. The first apparatus of claim 1, wherein the resource is a subset of a sub-band full-duplex resource.

3. The first apparatus of claim 1, wherein at least one of:
the muting pattern comprises an uplink muting pattern; or
the transmission via the resource comprises an uplink transmission via a physical uplink shared channel or a physical uplink control channel.

4. The first apparatus of claim 1, wherein the processing system is further configured to:
obtain a second configuration comprising the muting pattern.

5. The first apparatus of claim 1, wherein the processing system is further configured to:
apply the muting pattern to the first resource element of the first symbol if the muting pattern overlaps with an uplink transmission scheduled by the first configuration.

6. The first apparatus of claim 1, wherein the processing system is further configured to:
power boost the second resource element to achieve a target power level across all resource elements of the first symbol.

7. The first apparatus of claim 6, wherein:
the processing system is further configured to calculate a power boost factor according to the target power level and a quantity of resources elements of the first symbol that are muted; and
the power boost of the second resource element comprises multiplication of a power level for the second resource element by the power boost factor.

8. The first apparatus of claim 1, wherein the processing system is further configured to:
obtain an indication to activate the muting pattern; and
apply the muting pattern to the first resource element of the first symbol after the indication is obtained.

9. The first apparatus of claim 1, wherein the processing system is further configured to:
obtain a second configuration comprising an indication of a power boost factor; and
power boost the second resource element by the power boost factor.

10. The first apparatus of claim 9, wherein the second configuration comprises a radio resource control configuration message for an uplink channel.

11. The first apparatus of claim 9, wherein the indication of the power boost factor comprises:
a specific power boost factor; or
an index that maps to one power boost factor from a list of power boost factors.

12. The first apparatus of claim 1, wherein the processing system is further configured to:
obtain a second configuration comprising the muting pattern and an indication of whether power boosting is to be used with the muting pattern.

13. The first apparatus of claim 12, wherein:
the second configuration comprises an indication of a power boost factor; and
the processing system is further configured to power boost the second resource element by the power boost factor.

14. The first apparatus of claim 1, wherein the processing system is further configured to:
select a first power boost factor from a list of power boost factors; and
power boost the second resource element by the first power boost factor.

15. The first apparatus of claim 14, wherein the selected first power boost factor corresponds to a transmission type of the transmission.

16. The first apparatus of claim 14, wherein the processing system is further configured to:
obtain a second configuration that comprises the list of power boost factors.

17. The first apparatus of claim 14, wherein the list of power boost factors is specified by a wireless communication standard.

18. The first apparatus of claim 14, wherein:
the processing system is further configured to obtain an index that maps to a specific power boost factor within the list of power boost factors; and
the selected first power boost factor corresponds to the specific power boost factor.

19. The first apparatus of claim 18, wherein the processing system is further configured to:
obtain downlink control information (DCI) that activates a physical uplink shared channel transmission, the DCI comprising the index; or
obtain a medium access control-control element (MAC-CE) that activates or deactivates power boosting for at least one channel, the MAC-CE comprising the index.

20. The first apparatus of claim 1, wherein the processing system is further configured to:
apply the muting pattern to the first resource element of the first symbol if the transmission is associated with a channel of a particular type.

21. The first apparatus of claim 1, wherein the processing system is further configured to apply the muting pattern to the first resource element of the first symbol if at least one of:
the transmission is associated with an uplink transmission having a particular format or length; or
the transmission is an uplink transmission employing an orthogonal frequency division multiplexing waveform.

22. The first apparatus of claim 1, wherein the plurality of symbols comprise orthogonal frequency division multiplexed symbols.

23. The first apparatus of claim 1, further comprising:
a transceiver configured to receive the first configuration and transmit the first symbol,
wherein the first apparatus is configured as a UE.

24. A method for communication at a user equipment, the method comprising:
obtaining a first configuration that schedules a resource for the user equipment, the resource comprising a plurality of symbols; and
outputting a first symbol of the plurality of symbols for transmission via the resource, a first resource element of the first symbol being muted according to a muting pattern and a second resource element of the first symbol being power boosted.

25. A first apparatus for communication, comprising:
a processing system configured to:
output a first configuration for transmission, the first configuration scheduling a resource for a second apparatus; and
obtain a first symbol of a plurality of symbols via the resource, a first resource element of the first symbol being muted according to a muting pattern and a second resource element of the first symbol being power boosted.

26. The first apparatus of claim 25, wherein the processing system is further configured to:
measure cross-link interference using the first resource element, the cross-link interference being associated with transmissions by a network entity.

27. The first apparatus of claim 25, wherein the processing system is further configured to:
output a second configuration for transmission, the second configuration comprising the muting pattern.

28. The first apparatus of claim 25, wherein the processing system is further configured to:
output a second configuration for transmission, the second configuration comprising a power boost factor associated with the muting pattern.

29. The first apparatus of claim 25, wherein the processing system is further configured to:
output an indication to activate the muting pattern.

30. The first apparatus of claim 27, further comprising:
a transceiver configured to transmit the first configuration and receive the first symbol,
wherein the first apparatus is configured as a network entity.
